(19) United States
(12) Patent Application Publication
(10) Pub. No.: US 2013/0276622 A1
(43) Pub. Date: Oct. 24, 2013

(54) Positioning Of An Electronic Transducer On The Bass Bar Of The Violin Family Of Acoustical Instruments

(71) Applicant: Gary Bartig, Minneapolis, MN (US)

(72) Inventor: Gary Bartig, Minneapolis, MN (US)

(21) Appl. No.: 13/449,649

(22) Filed: Apr. 18, 2012

(51) Int. Cl. G10H 3/18

(52) U.S. Cl. 84/731

(57) ABSTRACT

In the violin family of acoustical instruments an electrical transducer designed to convert vibration into an electrical signal is to be mounted on the bass bar of such instruments. The electrical transducer may be mounted on the bass bar of the instrument, and the position of the electrical transducer on the bass bar may vary by instrument type. Such a location would be about the center of the bass bar. An electrical wire is connected to the electrical transducer on one end and to an electrical connector at the other end. The electrical connector passes through the sidewall of the instrument and is secured thereto. An external device may be connected to the electrical connector, placing the external device in communication with the electrical signals produced by the instrument when it is played. The external device may modify the electrical signal produced by the electrical transducer. Alternatively the electrical transducer may be wireless.

### BACKGROUND OF THE INVENTION

The present invention relates to electrical transducers and more particularly to the positioning of an electrical transducer on the bass bar of the violin family of acoustical instruments. For purposes of this application, the violin family includes the violin, the viola, the cello, and the upright bass or double bass. It is to be understood that the present invention has application to any stringed instrument employing a bridge on which musical strings are disposed, and is further adapted to receive a bass bar in the interior of the instrument.

The purpose of the electrical transducer to be employed with the aforementioned instruments is to amplify the sound of the instrument. Without sound amplification, various sounds are not heard while a group of instruments is playing anywhere from a concert hall, an outdoor venue or a noisy drinking establishment with live music for example.

Sound amplification devices employed with stringed musical instruments of the type discussed are well known. None of these devices have been employed in such a fashion where they have been secured inside the instrument on the bass bar.

In the present invention an electrical transducer is used to translate the vibrations of the acoustical musical instrument being played into an electrical signal. This electrical signal is then used to amplify the sound of the acoustic musical instrument. For the purposes of this invention, the electrical transducer may be also referred to as a pickup. There are several types of well known electrical transducers used in the musical industry. When an electrical transducer is referred to, it is to be understood that any electrical transducer which has the capability to change vibration to an electrical signal is being referred to. Additionally, wireless electrical transducers are also considered to be viable in this invention.

### SUMMARY OF THE INVENTION

The present invention comprises the placement of an electrical transducer on the bass bar on any of the Violin Family of instruments including a violin, viola, cello and upright bass. The present invention may also be employed with the recently constructed Octet developed primarily under the direction of American luthier Carleen Hutchins The Octet includes the following eight stringed instruments: a treble violin, a soprano violin, a mezzo violin, a tenor violin, a baritone violin, a small bass violin, and a contrabass violin. In the worldwide musical community, the aforementioned stringed instruments may go by other names, designations or slang terms; one example of such a stringed instrument called by another name would be the fiddle. It is to be understood that the present invention contemplates the placement of an electrical transducer on any musical instrument which has a bass bar, whatever such musical instrument may be called.

The placement of the electrical transducer on the bass bar may vary for an optimum signal to be generated. Additionally, each instrument may have its own “sweet spot” on the bass bar for transducer placement. This invention in no way limits where on the bass bar that the electrical transducer may be placed for any instrument. There may be a position on the bass bar that would give a desirable signal for a musician which may not give a perfect audio reproduction of the instrument.

In the future, designers of devices which produce music may produce such currently unknown musical instrument that includes a bass bar as one of the components. If such a musical instrument is created or designed it is anticipated that the current invention would be able to be mounted on the bass bar in such a fashion that the future acoustic instrument will be able to be amplified.

There are several advantages to using an electrical transducer on the bass bar. One is that there is an ease of installation compared to the transducer being inlaid into the top of the instrument in a position under the bridge foot, or inlaid into the bass bar. Additionally, placing the electrical transducer on the bass bar gives better tonal reproduction. The harmonic content of an electrical transducer placed on the bass bar better matches the harmonic content of a non-amplified musical instrument.

### BRIEF DESCRIPTION OF THE DRAWINGS

FIG. 1 is a generic representation of the top inside surface of a violin, viola, cello, double bass, and the eight instruments comprising the Octet.

### DETAILED DESCRIPTION OF THE INVENTION

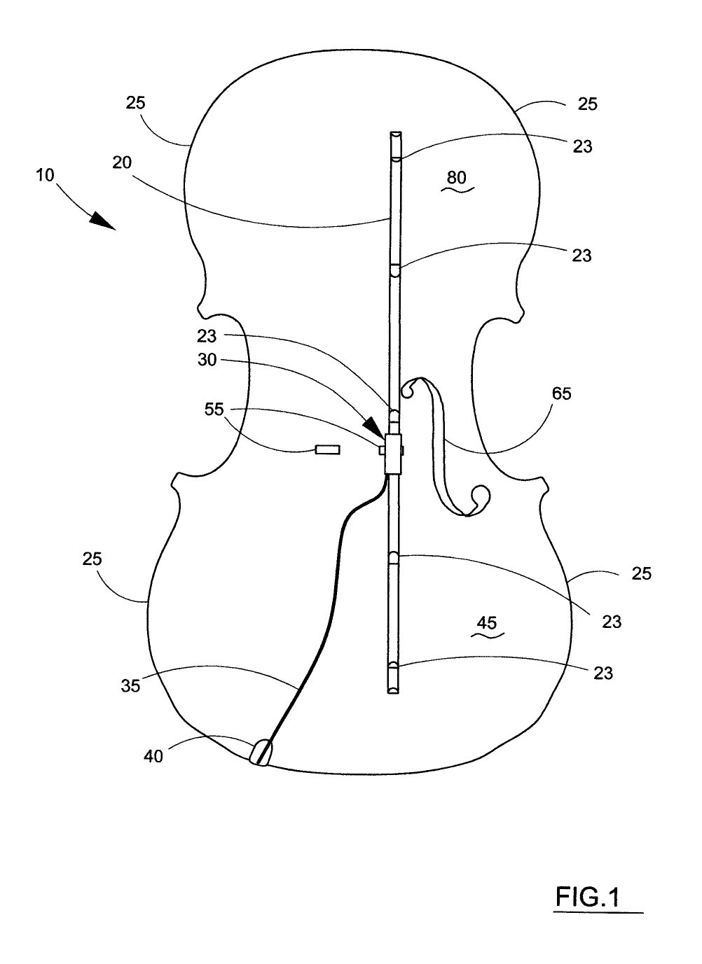

In FIG. 1, the term musical instrument is used and defined specifically to represent one of, or a group of, the following: the violin, the viola, the cello, the double bass, the treble violin, the soprano violin, the mezzo violin, the alto violin, the tenor violin, the baritone violin, the small bass violin and the contrabass violin.

Referring now to FIG. 1, the top inside surface 10 of a generic violin, viola, cello, double bass, and also of the eight instruments comprising the Octet is shown. These instruments have generally the same top inside surface with the exception of size. FIG. 1 shows the physical lengths, widths, heights and proportions generally of top inside surface 10 of whichever musical instrument is being discussed. This is due to the fact that mechanically, the top inside surface of each one of the musical instruments being discussed is identical to one another except for size. The perimeter of the top inside surface 10 is shown by element 25. The top inside surface 10 includes the bass bar 20. The bass bar 20 is identical to those used in the aforementioned musical instruments and is made of the same material as a conventional bass bar 20, and is glued to the top inside surface 10 of the musical instrument in the ordinary manner. The width, height and length of the bass bar 20 remains proportionately sized for each of the aforementioned acoustic musical instruments.

The invention centers around the placement of an electrical transducer 30 on the bass bar 20. Although the electrical transducer is shown roughly on the center of the bass bar 20, the invention does not limit the placement to this location. The electrical transducer 30 may be closer to the lower bout 45, just as it may be closer to the upper bout 80. Just for clarity, the electrical transducer 30 would not be mounted anywhere other than on the bass bar 20, the last sentence merely gives a sense of range of where that placement may be. In FIG. 1 the electrical transducer 30 is proximal the F-hole 65.

Referring specifically now to the elements 23 on the bass bar 20, one must recognize that the bass bar 20 is not a linear piece of wood. Near the distal and proximal ends of the bass bar 20, the bass bar 20 extends upwardly from the top inside surface 10 of the violin by a small but measurable amount. The black parabolic shadings 23 on the bass bar 20 as we move from the distal and proximal ends of the bass bar 20 towards the center, show how the height of the bass bar 20 extends upwardly and increases to a maximum generally quite near the center of the bass bar. This is merely a conventional bass bar 20 and this small discussion merely demonstrates what the parabolic shadings 23 indicate.

In the embodiment shown in FIG. 1, the electrical transducer 30 is shown placed on the bass bar 20 generally in a position of one of the feet of the bridge. The location where the bridge feet 55 would be if they penetrated through the violin to the top inside surface 10 of the violin (which they do not do) is shown by the two horizontal rectangles 55.

In the embodiment shown in FIG. 1, the electrical transducer 30, is a ceramic piezo transducer, and is further embedded within a generally rectangular brass structure. It is encased in an electrically grounded piece of brass to shield the ceramic piezo transducer from Radio Frequency (RF) interference. Although this embodiment uses brass, it is to be understood that the shield may be comprised of another metal, including but not limited to, copper, steel or aluminum. When a ceramic piezo transducer is unshielded, the RF interference causes undesirable electrical signals which when amplified sound like a background hum. The ceramic piezo transducer is a common acoustic transducer, however, the invention is not limited solely to the use of the ceramic piezo transducer. Other audio transducers include, but are not limited to, an electromagnet transducer device or a dynamic transducer device. Other means to reduce or eliminate RF interference are known and are considered within the scope of this invention. The wire 35 is in electrical communication with the ceramic piezo transducer.

The electrical transducer 30 as shown in FIG. 1 includes a wire 35 depending there from. The wire 35 extends from the electrical transducer 30 to the rib (the side of the instrument), not shown in FIG. 1. The wire 35 proximal the rib is connected to an electrical connector 40 of any desired type. The wire 35 may be of a coaxial type, where the center is the conductor and the covering is the ground. This would connect to the positive and negative connections on the electrical transducer 30. The electrical connector 40 may be secured through an appropriate point in the rib. The electrical connector 40 is generally a female electrical connector. This permits the electrical signal produced by the electrical transducer 30 to be connected to any of a myriad of electrical devices outside (external) of the musical instrument including but not limited to, an amplifier, an electrical signal processing circuit, or some other device which may be desired by the musician.

Additionally, it has been considered that a wireless electrical transducer may be mounted on the bass bar 20. It may be similarly shielded as the ceramic piezo transducer; however, this is merely an example and in no way is limiting. Different shielding may be utilized if desired.

The electrical transducer 30 may be connected to the bass bar 20 in any of a variety of ways. Materials which are highly viscous may be employed. Such materials would mate the electrical transducer 30 to the bass bar 20, but at the same time may remain viscous. These materials may include clay, putty, butyl putty, tape, moldable plastics, wood-particle and adhesive compositions and the like. Although not employed in the primary embodiment of the invention, any of the entire family of wood glues have been considered to be with in the scope of this invention. Again, the present invention may employ such attachment means for attaching the electrical transducer 30 to the bass bar 20, but it in no way is limited to such attachment materials or additional attachment materials. If employed, the wireless electrical transducer may be mounted in a similar fashion as discussed above, or by any known attachment means which permits the greatest sound reproduction quality available.

It is to be understood that the preceding is merely a detailed description of the invention, and that alterations to the disclosed invention can be made in accordance with the disclosure without departing from the spirit and scope of the invention. The preceding description is not meant to limit the scope of the invention. The scope of the invention is to be determined by the appended claims and their equivalents.

What is claimed is:

1. An electrical transducer connected to a bass bar of a musical instrument.

2. A musical instrument comprising,
a bass bar,
said bass bar having an electrical transducer affixed thereto,
wherein said musical instrument is selected from the group consisting of a violin, a viola, a cello, a double bass, a treble violin, a soprano violin, a mezzo violin, a tenor violin, a baritone violin, a small bass violin, and a contrabass violin.

3. A musical instrument including a bass bar,
said bass bar having a first length,
an electrical transducer,
said electrical transducer having a second length,
said electrical transducer attached to said bass bar.

4. A musical instrument as claimed in claim 3 whereby said electrical transducer is attached to said bass bar at a first position.

5. A musical instrument as claimed in claim 4 whereby said bass bar has a center, a distal end and a proximal end, the distance from said proximal end to said distal end is said first length, and said electrical transducer is attached to said bass bar at said first position, said first position selected to be within the range of 20% of said first length from said center toward said distal end and 20% of said first length from said center to said proximal end.

6. A musical instrument as claimed in claim 4 including a wire, said wire first side is connected to said electrical transducer and said wire second side is connected to an electrical connector, said electrical connector passes through a rib of said musical instrument whereby a second wire is adapted to be attached to said electrical connector, permitting an electrical signal to be passed from said electrical transducer to an external electrical device.

7. A musical instrument as claimed in claim 5 wherein said electrical transducer is located on said bass bar at a location proximal to the underside of a bridge foot location.

8. A musical instrument as claimed in claim 7 wherein said electrical transducer is attached at any location on said bass bar.

9. A musical instrument as claimed in claim 8 wherein said electrical transducer is a ceramic piezo transducer.

10. A musical instrument as claimed in claim 9 wherein a casing is adapted to hold said ceramic piezo transducer therein, said casing further adapted to reduce RF interference.

11. A musical instrument as claimed in claim 10 wherein said casing is constructed of a material which conducts electricity.

12. A musical instrument as claimed in claim 1 wherein said musical instrument is selected from the group consisting of a violin, a viola, a cello, a double bass, a treble violin, a soprano violin, a mezzo violin, a tenor violin, a baritone violin, a small bass violin, and a contrabass violin.

13. A musical instrument as claimed in claim 12 wherein said electrical transducer is affixed on said bass bar proximal to a center of said bass bar.

14. A musical instrument as claimed in claim 13 wherein said electrical transducer is affixed on said bass bar in a first position, said bass bar having a first length, said first position located anywhere in a range of ½ said length of said bass bar, where said center of said bass bar is a midpoint of said range.

15. A musical instrument as claimed in claim 14 wherein said electrical transducer is affixed to said bass bar from the group consisting of putty, butyl putty tape, and wood glue.

16. A musical instrument as claimed in claim 14 wherein said electrical transducer is affixed to said bass bar with an adhesive.

17. A musical instrument as claimed in claim 12 wherein said electrical transducer in inlaid into said bass bar.
